(19) United States
(12) Patent Application Publication
(10) Pub. No.: US 2016/0162828 A1
(43) Pub. Date: Jun. 9, 2016

(54) SYSTEM AND COMPUTER PROGRAM PRODUCT FOR INTELLIGENT SCORING AND RANKING OF STAFFING REQUISITIONS WITH UNIQUE POINTS BOUNTY SYSTEM FOR TASK ASSIGNMENTS WITH REWARDS THROUGH A CONNECTED ENTERPRISE

(71) Applicant: OVATIONV, INC., Wilmington, DE (US)

(72) Inventor: Kenneth D. BROWN, Orlando, FL (US)

(21) Appl. No.: 14/561,871

(22) Filed: Dec. 5, 2014

(51) Int. Cl. G06Q 10/06

(52) U.S. Cl. CPC G06Q 10/063118

(57) ABSTRACT

A system is disclosed including an electronic display to portray staffing workflow and pipeline management information for a plurality of staffing projects where the plurality of staffing projects are sorted based on a predetermined priority, a plurality of data entry systems configured to display at least one staffing project at one of the data entry systems and with an input device to provide updated information regarding the at least one staffing project, wherein the updated information is then displayed on the electronic display, and a point based accrual system configured to be applied to the staffing workflow and pipeline management information for each staffing project wherein a point value is assigned to each staffing project and wherein the point value for each staffing project is displayed on the electronic display in association with the respective staffing workflow and pipeline management information. A method and another system are also disclosed.

### BACKGROUND

Embodiments relate to a staffing agency and, more particularly, a system and method to provide for meeting staffing customer needs of third parties where efforts of entities of the staffing agency are efficiently used.

Currently, a staffing company is hired by a third party to find a specific employee or type of employee, based on a desired skill or knowledge base, for the third party. Staffing occurs in nearly all industries, such as, but not limited to, technology, accounting, legal, administration and trades. The staffing industry has used dry erase boards for over three decades to track workflow and pipeline management of the various staffing projects that may be angled at any given time. The staffing industry has also used “ATS” (or Applicant Tracking Systems) for the past two decades. An ATS is limited to storing information regarding staffing projects wherein these systems are primarily record management systems. Examples of an ATS include Bullhorn, Salesforce and Talent Rover. Such systems however fail to provide for ranking, assigning, prioritizing pending staffing jobs. Furthermore, all current ATS fail to provide an ability to recognize staffing agency employees who are truly performing well based on tasking provided each employee. Finally, all current ATS also fail to provide for accountability of the staffing agency employees.

While the ATS fails to provide realtime data about staffing projects, such as but not limited to who is assigned and value of the each individual project, staffing projects are usually included on the dry erase boards based on customer name, address, contact information, numbers of jobs to fulfill, positions/titles of jobs to fulfill, an amount each project is worth to the staffing company, job description, salary data, interview feedback, candidate profiles including payroll, etc. The time involved with revising dry erase boards and/or browsing through ATS, to determine information that may not be included on the white board, as priorities change or orders are fulfilled can be extremely time consuming.

Furthermore, from a staffing employee's perspective, knowing which order to fulfill may not always be clear, if not included on the white board because such information is not currently provided in the known ATS. Staffing employees typically make decisions on which orders to fulfill based upon emotional bias such a preferred sales person, favored company product, financial value of the project, etc. As a result, staffing companies typically are inefficient as most pending staffing orders are fulfilled based on a financial benefit to the staffing employee, which results in a more rewarding financial benefit to only a few staffing employees of the staffing company who fulfill the third party's staffing needs. For example, if three third parties hired a staffing company to meeting an employment need, where each hired the staffing company at various rates, typically the third party paying the highest rates will have their needs met first. This is due to the staffing employees seeing that a higher bonus may be realized by working on the third party paying a higher fee. Even when the employees of the staffing company are directed on which jobs to fulfill, seeing the white board with all information presented, the employees may independently work on the same fulfillment requirements for the third party which may provide the larger bonus to the staffing employee. Thus, although the third party paying the most may get their staffing needs met, the third parties paying less, may have their staffing needs unmet for an inordinate amount of time. This example is further illustrated in FIG. 1.

As illustrated in FIG. 1, in traditional methodologies and what is widely prevalent in the industry currently is a system under a “Money Bounty System.” In this system, most orders have a different commission and business value. However, the commission does not fully reflect a business value. Furthermore, staffing employees select with bias and often times nearly at random the requisition or third party order that they are focused on fulfilling based upon non-business or limited and manual business data points. This traditional method results in varied degrees of overlapping and inefficiently use of resources, namely of the staffing employee. Thus, though employees may be assigned particular fulfillment task, they will pursue other tasks in an attempt to earn more money. More specifically, this system allows any recruiter to work on any order where when a placement is completed money is earned. In essence, general business activities earn no money.

Staffing companies and third parties that use staffing companies would benefit from a system and method which allocates a work load of a staffing company so that all fulfillments are met more efficiently and timely than as currently occurs with the dry erase board system in combination with ATS, that does not actively rank or prioritize third party staffing requirements.

### SUMMARY

Embodiments relate to a system and a computer program product for efficiently using staffing resources to timely meeting staffing needs of third parties. The system comprises an electronic display configured to portray staffing workflow and pipeline management information for a plurality of staffing projects where the plurality of staffing projects are sorted in real-time based on a predetermined priority. The system also comprises a plurality of data entry systems configured to display at least one staffing project of the plurality of staffing projects at least at one of the data entry systems and with the at least one data entry system configured with an input device to provide updated information regarding the at least one of the plurality of staffing projects, wherein the updated information is then displayed on the electronic display. The system further comprises a point based accrual system configured to be applied to the staffing workflow and pipeline management information for each staffing project of the plurality of staffing projects wherein a point value is assigned to each staffing project of the plurality of staffing projects and wherein the point value for each staffing project is displayed on the electronic display in association with the respective staffing workflow and pipeline management information. The predetermined priority is based on at least one of past, current and projected business performance of each third party individually responsible for the staffing projects. The priority is adjusted in real time based upon actual business interactions including at least one of a candidate sent to a third party, a number of candidates interviewed by the third party, and the third party response time to report a decision made regarding the candidate or candidates.

The computer program product is a non-transitory processor readable storage medium, providing an executable computer program product, the executable computer program product comprising a computer software code that, when executed on a processor, causes the processor to portray staffing workflow and pipeline management information for a plurality of staffing projects where the plurality of staffing projects are sorted and ranked based on a predetermined priority on an electronic display. The processor is also caused to display at least one of the plurality of staffing projects on a display that is a part of at least one kiosk. The processor is also caused to allow updated information to be inputted from any one of a plurality of input devices regarding the at least one staffing projects of the plurality of staffing projects, wherein the updated information from any one of the plurality of input devices is then displayable on the electronic display. The processor is also caused to apply a point based accrual system to the staffing workflow and pipeline management information for each staffing project of the plurality of staffing projects wherein a point value is assigned to each staffing project of the plurality of staffing projects and wherein the point value for each staffing project is displayed on the electronic display in association with the respective staffing workflow and pipeline management information.

Another system comprises an electronic display configured to portray at least one of workflow and management information for a plurality of projects where the plurality of projects are sorted based on a predetermined priority. This system also comprises a plurality of data entry systems configured to display at least one project of the plurality of projects at least at one of the data entry systems and with an input device to provide updated information regarding the at least one project of the plurality of projects, wherein the updated information is then displayed on the electronic display and wherein any data entry system is configured to update information displayed on the electronic display. This system also comprises a point based accrual system configured to be applied to at least one project of the plurality of projects wherein a point value is assigned to each project of the plurality of projects and wherein the point value for each project is displayed on the electronic display in association with the respective at least one of workflow and pipeline management information. The predetermined priority is based on a priority factor based on a probability to fulfill a project of the plurality of projects.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 illustrates a prior art representation of how employees pursue staffing assignments;

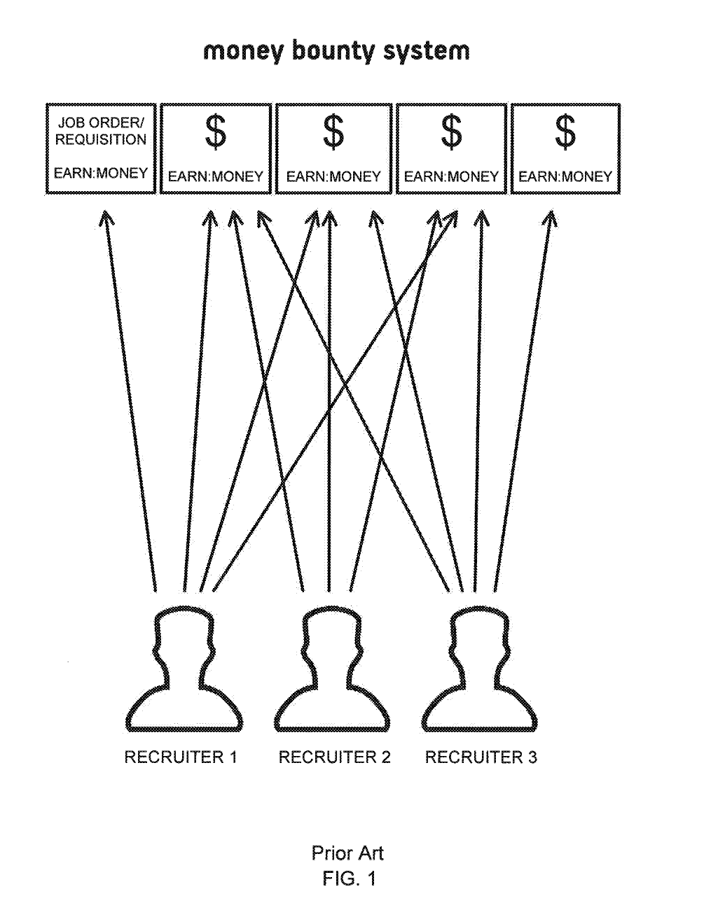

FIG. 2 illustrates a block diagram of an embodiment of a system;

FIG. 3 illustrates an embodiment of how employees pursue staffing assignments under a points bounty system;

FIG. 4 illustrates a block diagram illustrating work flow with the system;

FIG. 5 illustrates an embodiment of screen layouts;

FIG. 6 illustrates an embodiment of another screen layout; and

FIG. 7 illustrates a flowchart illustrating a method.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Though embodiments herein are disclosed with respect to a staffing company, the embodiments are applicable for other workflow and management information for a plurality of projects. Therefore, the association to staffing is not meant to be limiting. Thus, the non-limiting examples and embodiments disclosed below may also be applicable to non-staffing matters.

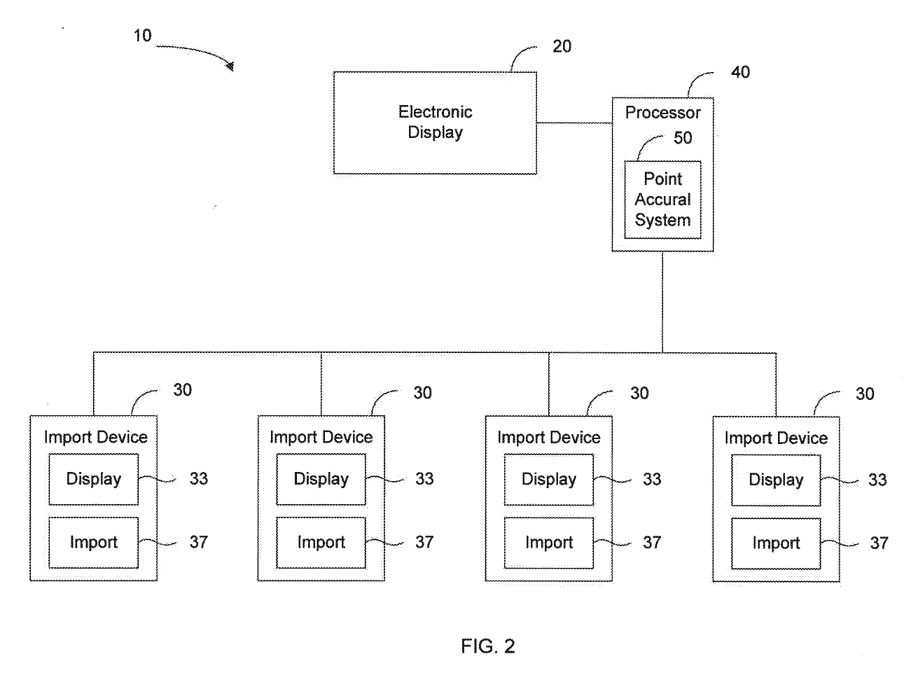

FIG. 2 illustrates a system for meeting staffing needs of third parties where efforts of entities of the staffing agency are efficiently used. As illustrated, in the system 10, an electronic display 20 may be configured to portray staffing workflow and pipeline management information for a plurality of staffing projects where the plurality of staffing projects are sorted based on a predetermined priority. A non-limiting example of the electronic display 20 may be a flat panel display that performs as a video display, output device for presentation of images transmitted electronically, for visual reception, without producing a permanent record. When compared to a dry erase board, as currently used, many repetitive uses before having to discard the electronic display may be realized. The predetermined priority may be based on a priority factor based on a multitude of data points about the business relationship between the third party client or customer and the staffing company. There are active data points which the application's user, a staffing employee, may enter into the system upon entering a contract or permanent job order. Those active data points may include, but are not limited to, how many placements have been conducted prior, the third party's rates versus market rates, how long the third party has been a client, how many people are they willing to hire in the next 30 days, etc. The passive data points that factor into the scoring and ranking methodology may be learned by the application itself using machine learning. The machine creates a bias score for each active data point that adjust the active data entered to be extremely factually accurate. Both the passive and active data points may be factored into the scoring and ranking of a staffing project of the plurality of staffing projects.

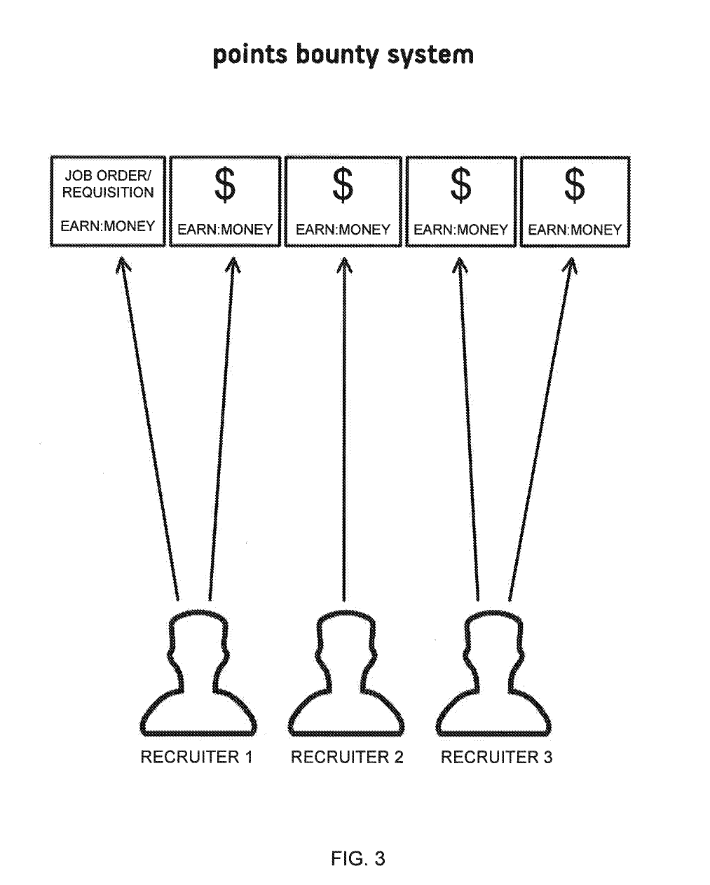

FIG. 3 illustrates an embodiment of information which may be provided on the electronic display as compared to a prior art rendition. The layout, features, and type of information included are non-limiting and are provided as non-limiting examples only. As illustrated, the relationship that staffing employees have with the third party's staffing requisitions may be identified. A ‘Points Bounty System’ is illustrated where each staffing employee is assigned a unique third party client staffing requisition and that person then has the ability to capture unique points internally for fulfilling that third party request and the system creates a method whereby if resources were to overlap that the overlapping behavior with have no incentive to do so as no points are awarded for other staffing employees third party fulfillment request. To summarize the traditional, mainstream method disclosed above once the request is fulfilled money is earned. In an embodiment of the Points Bounty System, or point based accrual system, the points are earned once the request is fulfilled. By each staffing employee only being able to earn points on specific, assigned or ‘drafted’ third party orders team behavior is incentivize while an elimination of internal cannibalization of resources may be realized, and incentivize people may be more focused on the singular task at hand. In another embodiment, the ‘Points Bounty System’ also allows staffing companies to deduct points for failing to fulfill assigned or drafted third party requests while the traditional ‘Money Bounty System’ does not allow for a deduction in wages for failed assignments based on legality issues. Thus, under the ‘Money Bounty System’ complete a placement, earn points. Points accurately reflect business value and business priority in real time. The point can only be captured by the assigned recruiter. No duplication of work effort occurs, thus ensuring optimal efficiency.

The point based accrual system may have a rewards system that allows staffing employees to redeem their points for various rewards including but not limited to paid days off from work, charitable donations, vacations, vehicles, gift cards, electronics, etc. The point accrual method may ensure that resources (namely employees) are used efficiently and staffing employees have a singular focus, which results in an avoidance of duplicative efforts and thus inefficient work behavior. The display system may allow all users to see the point accrual totals for all users in addition to features like local weather, global news, internal news, current contract job orders, current permanent placement job orders, current submits (resumes sent to clients), current interviews (candidates meeting with clients) and current deals (candidates who were successfully placed with clients).

Turning back to FIG. 2, a plurality of data entry systems 30 may also be provided. Each data entry system 30 may be configured to display 33 (in a lesser display device than the electronic display) at least one staffing project of the plurality of staffing projects. An input device 37 may also be provided to provide a user an ability to update information regarding the at least one of the plurality of staffing projects, wherein the updated information is then displayed on the electronic display. With respect to the current dry erase board system, all data is typically only available on the dry erase board wherein all updates are only displayed to all others through by way of the dry erase board. Thus, a single point of failure is realized with the dry erase board system as only a single input port is available, namely writing the updates on the dry erase board. Though an ATS may also be used, it is primarily used for record management. As disclosed herein, this single point of failure is removed as updates may be made from any one of the plurality of data entry systems 30. The sort of updates may include, but are not limited to, information regarding candidate sent to a third party, a number of candidates interviewed by the third party, and the third party response time to report a decision made regarding the candidate or candidates. Response time may be determined by a processor based on when information is provided the third party and when information is submitted by the third party. Furthermore, the existing information regarding a specific staffing project may also be displayed at the data entry system 30.

The data entry system 30 may be a part of a kiosk, or small booth. The data entry system 30 may also be a surface mounted tablet on a workspace or even simply displayed on a desktop monitor as a status or update bar. In other non-limiting examples, the data entry system may be available via at least one of a mobile device, such as, but not limited to, a smartphone, a tablet computer, a laptop computer, desktop computer, a touch screen television etc.

As further illustrated, the data entry systems 30 may be configured to connect to the electronic display 20 through an independent processor 40 that may or may not be local, remote or cloud based configured to communicate and prioritize communications between the electronic display and the plurality of input devices 30. In another non-limiting example, the data entry systems 30 may individually connect or wirelessly to the electronic display 20. In this embodiment, one of the data entry systems 30 may provide the processing capabilities as discussed above and the electronic display serves to merely display data and nothing more.

In another non-limiting example, using the an embodiment disclosed herein, if a staffing agency has offices in a plurality of locations, one of the embodiments disclosed herein may be used so that an office in a remote location may be provided current real time information regarding staffing positions to be filed wherein employees at the remote location can work as effectively and efficiently as employees at a more localized office since all offices will be provided the same information at approximately the same time.

A point based accrual system 50 may be utilized. The point based accrual system 50 may reside on the processor 40 discussed above or an independent processor (not disclosed). The point based accrual system 50 may be configured to be applied to the staffing workflow and pipeline management information for each staffing project of the plurality of staffing projects wherein a point value is assigned to each staffing project of the plurality of staffing projects and wherein the point value for each staffing project is displayed on the electronic display in association with the respective staffing workflow and pipeline management information. The point based accrual system 50 may provide for a gamification system configured to provide for allocate points per staffing project of the plurality of staffing projects. Thus, in a non-limiting example, determining the staffing project to fulfill may be determined by the point value assigned to at least one staffing project. In another non-limiting example, the point value assigned to the at least one staffing project may be determined with the predetermined priority.

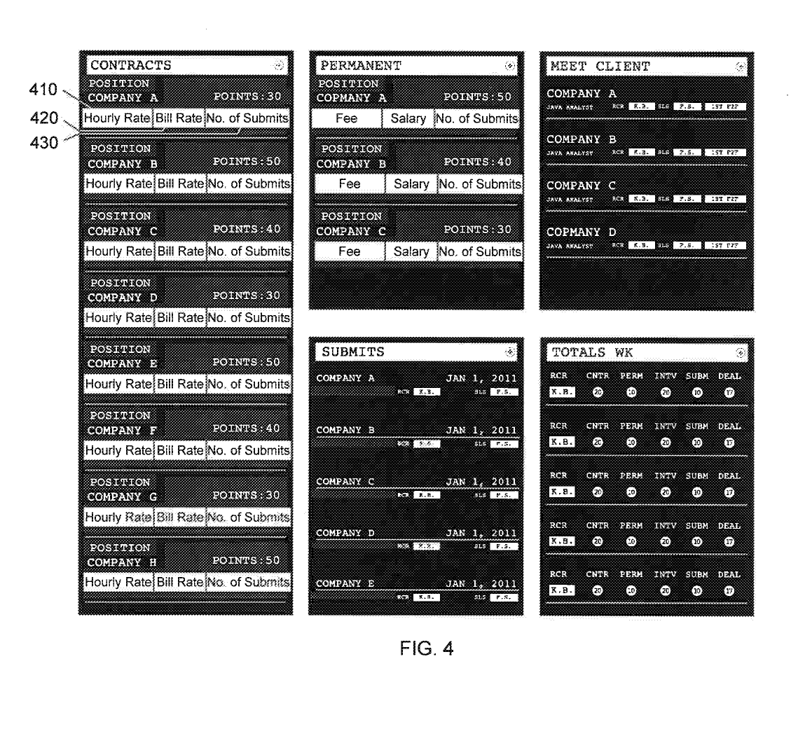

FIG. 4 illustrates a block diagram illustrating work flow with the system. Utilizing the point based accrual system 50, provides for a more efficient work flow as employees of a staffing company are not all attempting to fulfill the same job requests. Instead, with a point based system, as illustrated as POINTS, where as illustrated the points may be the same even though a resulting bonus to the employee may be higher, employees are more likely to work on tasks assigned and not attempt to secure higher bonuses by poaching other fellow employees' assignments. Thus as illustrated, each employee, or recruiter, may be assigned a task and are more likely to stay focused on their respective task as the point distribution may be the same. The points system preserves the competitive spirit that is currently prevalent throughout the staffing industry today however it allows people to be competitive with themselves and prevents the severe overlapping that currently occurs in the staffing and recruiting industry currently. Though the term POINTS is shown, other terms may be used as well, such as, but not limited to, ratings, bounty, etc.

Also illustrated, such as under the CONTRACTS category, which may be for contract positions, such information that may be listed, but not limited to, includes the company names, job title or position, pay for the position 410 (such as, but not limited to, a hourly rate), and the number of candidates, or submits 430, the company wishes to have submitted, and rate 420 at which the company is paying the staffing agency. Though not illustrated, other information may also be displayed, such as, but not limited to, location of the job. As illustrated further, non-limiting representative jobs may also be listed. Under the PERMANENT category, which may be for permanent positions to be filled, the fee to the staffing agency, salary of potential new hire, and number of candidates provided to the company may be included. As discussed above, other information may also be included, if desired.

Thus, under the SUBMITS category, the RCR is an abbreviation for recruiter and SLS stands for sales where the sales person initials populates the field. Under the MEET CLIENT category, 1ST F2F stands for first face to face contact between the recruiter and the point of contact for the client. As previously defined, RCR is the abbreviation for recruiter and SLS is the abbreviation for sales. For the TOTALS WK category, which is totals for a week, the recruiter is identified. Under each type of contact or action, the number of points may be identified and/or the number of completed tasks per category may be identified. As further shown, CNTR is an abbreviation for contract placement, PERM is an abbreviation for permanent placement, INTV is an abbreviation for interview, SUBM is an abbreviation for submit, such as, but not limited to resumes submitted to clients, and DEAL is and abbreviation for the number of placements made. Though shown for the week, other time periods may also be shown, such as, but not limited to yearly, quarterly, monthly, daily, and hourly.

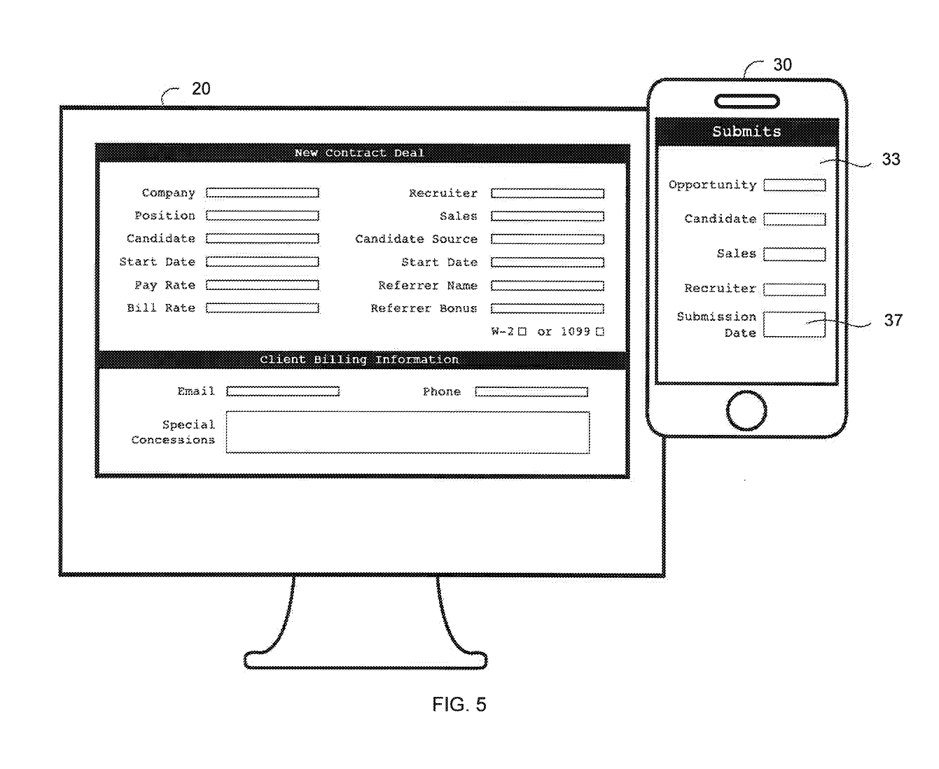

FIG. 5 illustrates an embodiment of screen layouts. As illustrated, a new contract deal screen may be viewable on the electronic display 20. Through the input device 30, such information as candidate, sales, recruiter, and submission date may be entered. The Opportunity may be the assigned identified for the particular task. Once the recruiter selects submit after populating the information on the input device 30, the information is immediately viewable on the electronic display 20.

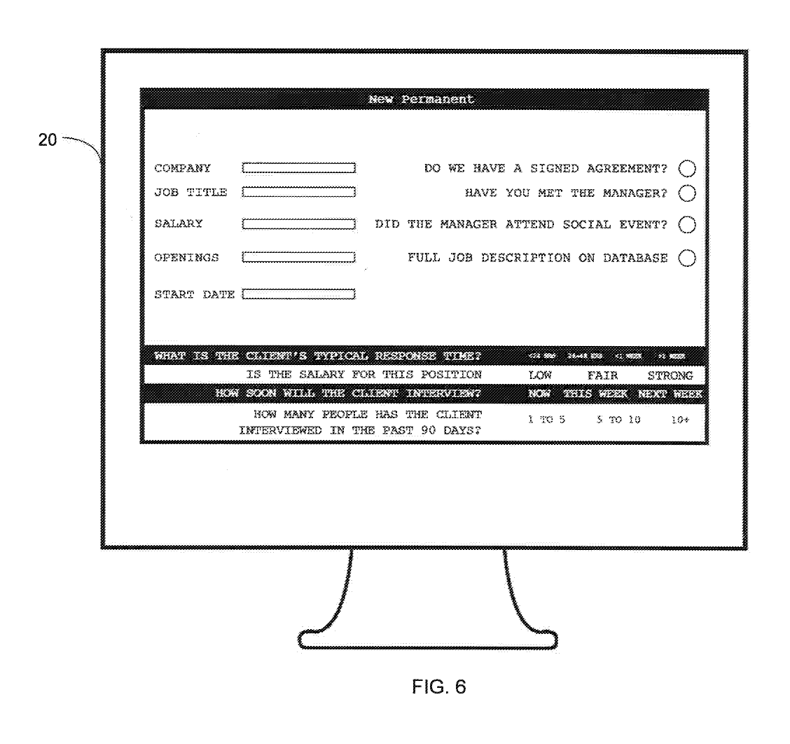

FIG. 6 illustrates an embodiment of another screen layout. As further illustrated, information regarding the client's response time and timeliness of the client conducting an interview is also collected where it is viewable on the electronic display 20 and when requested, on the input device 30.

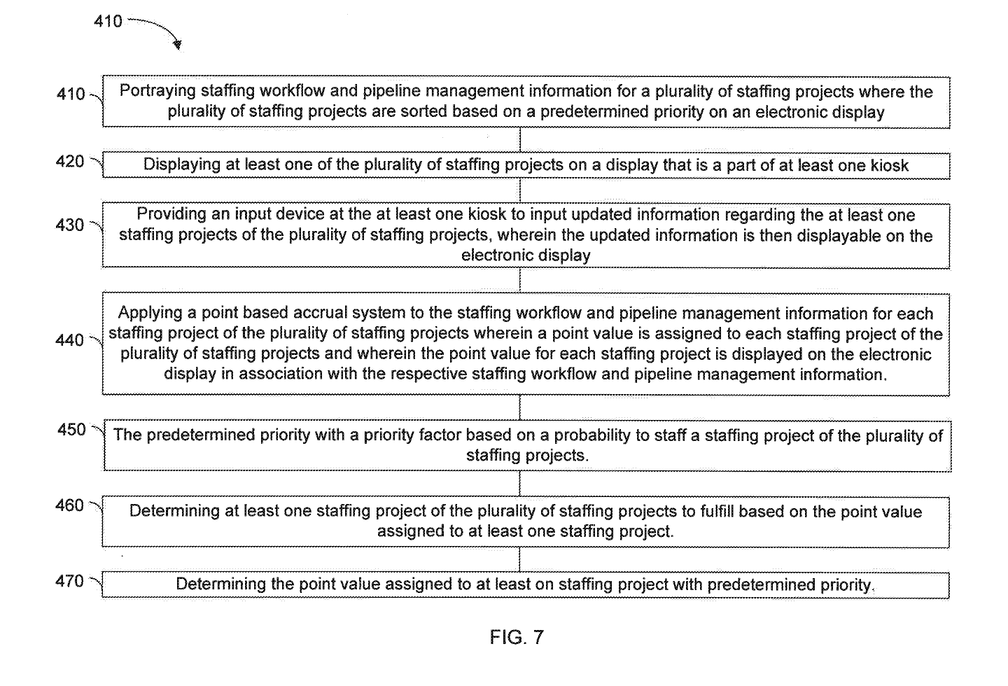

FIG. 7 illustrates a flowchart illustrating a method. The method 400 may comprise portraying staffing workflow and pipeline management information for a plurality of staffing projects where the plurality of staffing projects are sorted and ranked based on a predetermined priority on an electronic display, at 410. The method 400 may further comprise displaying at least one staffing project of the plurality of staffing projects on a display that is a part of at least one kiosk, at 420. The method may further comprise providing a plurality of input devices each at an individual kiosk to input updated information regarding the at least one staffing projects of the plurality of staffing projects, wherein the updated information from any one of the plurality of input devices is then displayable on the electronic display, at 430. The method may also comprise applying a point based accrual system to the staffing workflow and pipeline management information for each staffing project of the plurality of staffing projects wherein a point value is assigned to each staffing project of the plurality of staffing projects and wherein the point value for each staffing project is displayed on the electronic display in association with the respective staffing workflow and pipeline management information, at 440.

The method may further comprise determining the predetermined priority with a priority factor based on a probability to staff a staffing project of the plurality of staffing projects, at 450. The point based accrual system may comprise a gamification system configured to provide for the point value for the at least one staffing project of the plurality of staffing projects. The method 400 may further comprise determining at least one staffing project of the plurality of staffing projects to fulfill based on the point value assigned to at least one staffing project, at 460. The method 400 may further comprise determining the point value assigned to at least on staffing project with predetermined priority, at 470.

Though the steps of the method 400 are shown in a sequential order, this order is not necessarily required whereas the steps may be performed in any number of other orders. Additionally, steps 450, 460, and 470.

Persons skilled in the art will recognize that an apparatus, such as a data processing system, including a CPU, memory, I/O, program storage, a connecting bus, and other appropriate components, could be programmed or otherwise designed to facilitate the practice of embodiments of the method. Such a system would include appropriate program means for executing the method. Also, an article of manufacture, such as a pre-recorded disk, computer readable media, or other similar computer program product, for use with a data processing system, could include a storage medium and program means recorded thereon for directing the data processing system to facilitate the practice of the method.

Embodiments may also be described in the general context of computer-executable instructions, such as program modules, being executed by any device such as, but not limited to, a computer, designed to accept data, perform prescribed mathematical and/or logical operations usually at high speed, where results of such operations may or may not be displayed. Generally, program modules include routines, programs, objects, components, data structures, etc., that perform particular tasks or implement particular abstract data types. In an embodiment, the software programs that underlie embodiments can be coded in different programming languages for use with different devices, or platforms. It will be appreciated, however, that the principles that underlie the embodiments can be implemented with other types of computer software technologies as well.

Moreover, those skilled in the art will appreciate that the embodiments may be practiced with other computer system configurations, multiprocessor systems, microprocessor-based or programmable consumer electronics, minicomputers, mainframe computers, and the like. Embodiments may also be practiced in distributed computing environments where tasks are performed by processing devices located at different locations that are linked through at least one communications network. In a distributed computing environment, program modules may be located in both local and remote computer storage media including memory storage devices.

In view of the above, a non-transitory processor readable storage medium is provided. The storage medium comprises an executable computer program product which further comprises a computer software code that, when executed on a processor, causes the processor to perform certain steps or processes. Such steps include, but are not limited to, portraying staffing workflow and pipeline management information for a plurality of staffing projects where the plurality of staffing projects are sorted and ranked based on a predetermined priority on an electronic display, displaying at least one staffing project of the plurality of staffing projects on a display that is a part of at least one kiosk, inputting updated information regarding the at least one staffing projects of the plurality of staffing projects from the at least one kiosk, wherein the updated information from any one of the plurality of input devices is then displayable on the electronic display, and applying a point based accrual system to the staffing workflow and pipeline management information for each staffing project of the plurality of staffing projects wherein a point value is assigned to each staffing project of the plurality of staffing projects and wherein the point value for each staffing project is displayed on the electronic display in association with the respective staffing workflow and pipeline management information.

Thus, embodiments disclosed above provide for an ability to rank staffing projects based on a plurality of parameters, assign projects to specific employees, prioritize which projects should be completed, or at least started, in a preferred order, account for how employees are truly doing, and recognize employees for completing assigned tasking.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

What is claim is:

1. A system comprising:
an electronic display configured to portray staffing workflow and pipeline management information for a plurality of staffing projects where the plurality of staffing projects are sorted in real-time based on a predetermined priority;
a plurality of data entry systems configured to display at least one staffing project of the plurality of staffing projects at least at one of the data entry systems and with the at least one data entry system configured with an input device to provide updated information regarding the at least one of the plurality of staffing projects, wherein the updated information is then displayed on the electronic display; and
a point based accrual system configured to be applied to the staffing workflow and pipeline management information for each staffing project of the plurality of staffing projects wherein a point value is assigned to each staffing project of the plurality of staffing projects and wherein the point value for each staffing project is displayed on the electronic display in association with the respective staffing workflow and pipeline management information;
wherein the predetermined priority is based on at least one of past, current and projected business performance of each third party individually responsible for the staffing projects; and
wherein priority is adjusted in real time based upon actual business interactions including at least one of a candidate sent to a third party, a number of candidates interviewed by the third party, and the third party response time to report a decision made regarding the candidate or candidates.

2. The system according to claim 1, wherein a data entry system of the plurality of data entry systems comprises a kiosk further comprising the input device and a display device, the display device is configured to display information provided on the electronic display regarding at least one staffing project.

3. The system according to claim 1, wherein the point based accrual system provides for a gamification system configured to provide for allocation of points per staffing project of the plurality of staffing projects to reward an individual for completing the staffing project.

4. The system according to claim 1, wherein the predetermined priority further comprises a priority factor based on a probability of actual fulfillment of a third party staffing project of the plurality of staffing projects.

5. The system according to claim 1, wherein determining the at least one staffing project of the plurality of staffing projects to fulfill is determined by the point value assigned to at least one staffing project.

6. The system according to claim 1, wherein the point value assigned to the at least one staffing project is determined with the predetermined priority.

7. A non-transitory processor readable storage medium, providing an executable computer program product, the executable computer program product comprising a computer software code that, when executed on a processor, causes the processor to:
portray staffing workflow and pipeline management information for a plurality of staffing projects where the plurality of staffing projects are sorted and ranked based on a predetermined priority on an electronic display;
display at least one of the plurality of staffing projects on a display that is a part of at least one kiosk;
allow updated information to be inputted from any one of a plurality of input devices regarding the at least one staffing projects of the plurality of staffing projects, wherein the updated information from any one of the plurality of input devices is then displayable on the electronic display; and
apply a point based accrual system to the staffing workflow and pipeline management information for each staffing project of the plurality of staffing projects wherein a point value is assigned to each staffing project of the plurality of staffing projects and wherein the point value for each staffing project is displayed on the electronic display in association with the respective staffing workflow and pipeline management information.

8. The non-transitory processor readable storage medium according to claim 7, when executed on the processor, further causes the processor to determine the predetermined priority with a priority factor based on a probability to staff a staffing project of the plurality of staffing projects.

9. The non-transitory processor readable storage medium according to claim 7, when executed on the processor, further causes the processor to determine the predetermined priority with at least one of past, current and projected business performance of each third party individually responsible for the staffing projects;

10. The non-transitory processor readable storage medium according to claim 9, when executed on the processor, further causes the processor to adjust the priority in real time based upon actual business interactions including at least one of a candidate sent to a third party, a number of candidates interviewed by the third party, and the third party response time to report a decision made regarding the candidate or candidates.

11. The non-transitory processor readable storage medium according to claim 7, wherein the point based accrual system comprises a gamification system configured to provide for the point value for the at least one staffing project of the plurality of staffing projects.

12. The non-transitory processor readable storage medium according to claim 7, when executed on the processor, further causes the processor to determine at least one staffing project of the plurality of staffing projects to fulfill based on the point value assigned to at least one staffing project.

13. The non-transitory processor readable storage medium according to claim 7, when executed on the processor, further causes the processor to determine the point value assigned to at least on staffing project with predetermined priority.

14. A system, comprising:
an electronic display configured to portray at least one of workflow and management information for a plurality of projects where the plurality of projects are sorted based on a predetermined priority;
a plurality of data entry systems configured to display at least one project of the plurality of projects at least at one of the data entry systems and with an input device to provide updated information regarding the at least one project of the plurality of projects, wherein the updated information is then displayed on the electronic display and wherein any data entry system is configured to update information displayed on the electronic display; and
a point based accrual system configured to be applied to at least one project of the plurality of projects wherein a point value is assigned to each project of the plurality of projects and wherein the point value for each project is displayed on the electronic display in association with the respective at least one of workflow and pipeline management information;
wherein the predetermined priority is based on a priority factor based on a probability to fulfill a project of the plurality of projects.

15. The system according to claim 15, wherein the predetermined priority is based on at least one of past, current and projected business performance of each third party individually responsible for the project.

16. The system according to claim 16, wherein the priority is adjusted in real time based upon actual business interactions.

17. The system according to claim 16, wherein a data entry system of the plurality of data entry systems comprises a kiosk further comprising the input device and a display device, the display device is configured to display information provided on the electronic display regarding at least one project.

18. The system according to claim 16, wherein the point based accrual system provides for a gamification system configured to provide for the point value for the at least one staffing project of the plurality of staffing projects.

19. The system according to claim 16, wherein determining at least one project of the plurality of projects to fulfill is determined by the point value assigned to the at least one project.

20. The system according to claim 16, wherein the point value assigned to the at least one project is determined with the predetermined priority.
